(19) United States
(12) Patent Application Publication
(10) Pub. No.: US 2015/0359185 A1
(43) Pub. Date: Dec. 17, 2015

(54) Untethered Irrigation Device and Method

(71) Applicant: Jonathan Guy, Austin, TX (US)

(72) Inventor: Jonathan Guy, Austin, TX (US)

(21) Appl. No.: 14/742,387

(22) Filed: Jun. 17, 2015

Related U.S. Application Data
(60) Provisional application No. 62/013,054, filed on Jun. 17, 2014.
(60) Provisional application No. 62/116,883, filed on Feb. 16, 2015.

(51) Int. Cl. A01G 25/09; G05D 1/00; A01G 25/16

(52) U.S. Cl. CPC A01G 25/09; A01G 25/167; G05D 1/0088

(57) ABSTRACT

A device for irrigating soil has a chassis having wheels or tracks for motion, the chassis having one or more water sprinklers with streams directed at the soil, a water storage tank, and a sloped catchment surface having one or more sloped planes or curved surfaces for receiving water from a refill station into the water storage tank, wherein, under the control of an electronic circuit, the irrigation device can refill the water tank by positioning any part of the catchment surface under a water stream from the refill station. A method has the steps of measuring soil moisture at remote locations, refilling the mobile robot using a gravity feed water stream, defining a route for distribution of water, traversing the irrigation routes, refilling water according to soil moisture measurements, storing photovoltaic energy in a battery, and rotating, to a compass heading such that the photovoltaic array is optimally oriented.

### CROSS-REFERENCES TO RELATED APPLICATIONS

The current application claims the benefit of two earlier-filed provisional patent applications.

The first provisional patent application was filed on Jun. 17, 2014 and was assigned application Ser. No. 62/013,054 It listed the same inventor.

The second provisional patent application was filed on Feb. 16, 2015 and was assigned application Ser. No. 62/116,883. It listed the same inventor.

### BACKGROUND

1. Field of the Invention

The invention relates to a device and a method for irrigation areas of ground, specifically to an improved mobile irrigation device and method.

2. Description of Related Art

Efficient irrigation requires the delivery of water to planted areas such that water waste due to evaporating, distribution to paved areas, leaks, under-watering, and over-watering is minimized. Irrigation is further complicated because water requirements and moisture levels vary even over a few feet of distance within a planted area. Most irrigation systems employ sprinkler systems, fed by supply hoses or pipes, which operate in zones covering hundreds of square feet. Mobile irrigation systems use streams of water and also operate in large zones. The US Environmental Protection Agency states that as much 50% of water used for irrigation is wasted.

Water waste is primarily a result of the limitations of broadcasting water with a sprinkler and secondarily a result of issues with leaks in supply pipe underground. Sprinklers typically have a 6:1 variation in water distribution over their directed area. Additionally, even with intelligent irrigation controls, the granularity of control is limited to the size of each controlled zone which may itself consist of 20 or more individual sprinklers.

Other than watering by hand, drip irrigation systems are widely accepted as the most efficient system for irrigating planted areas, however drip irrigation is very difficult to install and maintain in lawn areas as it must be located in the soil. Additionally, the small apertures in the irrigation heads are often blocked by tiny roots, minerals, and debris.

Additionally, fixed irrigation systems are both expensive and inflexible when the planting configuration changes. Thus there is the need for a system that can irrigate areas without the limitations of fixed sprinkler and drip irrigation systems. This invention describes a lawn irrigation device that provides the efficiency benefits of hand-watering while being fully automated and without the encumbrance of a water supply hose.

The object of the invention is to provide a practical device and a method for optimally irrigating areas of grass that is simple to install and can operate autonomously for extended periods, but is not restricted to monoculture lawns and may be applied to other planted areas.

An automated mobile device with an integral water tank provides a solution to the limitations and inefficiencies of pipe and hose-fed sprinkler systems. By carrying water and applying water directly to the soil, water can be applied to sufficiently irrigate each area to local requirements without the restrictions imposed by sprinkler coverage and zones.

The practical implementation of such a device has several significant challenges. One problem is a simple and reliable mechanism for refilling the mobile device with water. The mobile device must be precisely located to transfer water from the refill station into a tank.

U.S. Pat. No. 8,989,907 describes a mobile irrigation apparatus containing a water tank and a microwave moisture sensor. This patent annotates a filling nozzle but does not address the alignment or engagement method with the refill station. The accuracy of the GPS navigation method described is this patent is insufficient to align the filing nozzle with the refill station. Thus there is the need for a device that simply and reliably transfers water from a refill station to a mobile irrigation device.

An additional problem with implementing such a device is determining the limits of the grass area for navigation. If the device position is uncertain to even a few inches, water may be applied to paved areas, resulting is water waste comparable to conventional sprinkler systems. Again, a GPS system is unable to provide sufficient positional accuracy. Differential and assisted GPS systems can improve base GPS accuracy and resolution, but are complex and expensive while still providing marginally acceptable accuracy for precise water application. A common system, used commonly in automated lawn-mowing devices, employs a perimeter wire that transmits an electromagnetic tone which is detected by the device. This system provides a precise perimeter but requires installation of a wire, transmitter, and a power supply. Thus there is the need for a means to determine where a grassed area transitions into pavement.

From an installation perspective it is also highly desirable to avoid installation of a power source to recharge the automated irrigation device. Many homes and commercial buildings do not have convenient outdoor power sources and building owners prefer not to have to run electrical service to new areas. Photovoltaic arrays may be employed to provide power without requiring an external power source. However, the mass of water is so large that a device with a water capacity of just 3 US gallons, weighing 25 lbs will require a 1 m² solar panel in typical operation. Thus there is the need for a method for efficiency using solar power from an appropriately sized photovoltaic array.

U.S. Pat. No. 8,989,907 describes a mobile irrigation apparatus containing a water tank and a microwave moisture sensor as means of sensing soil moisture. Such sensors are expensive and typically consume more than 5W of electrical power. Commercially available active microwave sensors for moisture require significant power. The microwave sensor used commonly for soil measurements consumes 4 Watts in typical operation with a penetration depth of only 75-100 mm. For a device operating from solar energy, a microwave moisture sensor is impractical from an operating power perspective. By comparison the total electrical power consumption of a mobile device carrying 12 liters of water is about 5 Watts. Thus there is the need for a means to determine the moisture over a wide area but with power consumption substantially less than the power required by the drive motors.

A further limitation of the invention described in U.S. Pat. No. 8,989,907 is the mobile car travel required to an area to measure soil moisture. If irrigation is not required, then the energy used to travel to that location is wasted. Additionally the mobile car is unable to plan an energy efficient route based on real-time soil moisture information. If the mobile car were able to tell in advance how much water was required, the path could be adjusted so that greatest mass of water is distributed at the beginning of a route rather potentially at the end. Thus there is the need for an irrigation device that is capable of remotely sensing soil moisture, operating efficiently under solar-power during both the refill and irrigation phases of operation.

### SUMMARY

A device for irrigating soil has a chassis having wheels or tracks for motion, the chassis having one or more water sprinklers with streams directed at the soil, a water storage tank, and a sloped catchment surface having one or more sloped planes or curved surfaces for receiving water from a refill station into the water storage tank, wherein, under the control of an electronic circuit, the irrigation device can refill the water tank by positioning any part of the catchment surface under a water stream from the refill station.

The irrigation device may have photovoltaic solar panels installed on the sloped catchment surface, wherein the mobile irrigator is configured to operate exclusively from solar power. It may also have exterior electrical contacts, wherein the mobile irrigator can activate an electric water valve on the refill station.

In an embodiment the device has a plurality of wireless moisture beacons, wherein the moisture information and position information by way of radio signal strength is sent to the mobile irrigator. The device may have one or more machine vision cameras, oriented to face the ground wherein the control module can determine the transition between the planted area and the surrounding paved areas.

A method for optimally irrigating soil using solar energy has the steps of measuring soil moisture at remote locations using a plurality of wireless moisture beacons, refilling the mobile irrigator using a gravity feed water stream onto a catchment roof, defining a route for distribution of water based on watering the driest areas first, traversing the planned irrigation routes, refilling and distributing water according to soil moisture measurements for each location, storing photovoltaic energy in a battery optimally, by moving to the sunniest location based on time of day, historical data, environmental conditions, latitude and longitude, and rotating, while route navigation is paused, to a compass heading such that the photovoltaic array is optimally oriented with respect to the sun's position for peak photovoltaic output power.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 illustrates an irrigation device, having a mobile robot, refill station, and moisture beacons, according to an embodiment of the present invention.

FIG. 2 illustrates the sloped roof and water catchment channel of the mobile robot, according to an embodiment of the present invention.

FIG. 3 illustrates a cross sectional view of the mobile robot and refill station, according to an embodiment of the present invention.

FIG. 4 illustrates the mobile robot engaged with a refill station, according to an embodiment of the present invention.

FIG. 5 illustrates a wireless moisture sensor beacon, according to an embodiment of the present invention.

FIG. 6 shows method used for irrigating such that only photovoltaic energy is required, according to an embodiment of the present invention.

FIG. 7 shows step by step navigation of the mobile robot toward a wireless navigation beacon, according to an embodiment of the present invention.

### DETAILED DESCRIPTION OF THE INVENTION

Embodiments are directed to devices, systems, and methods for irrigating soil for lawns, gardens, crops, and around trees. Certain embodiments are directed to a mobile robotic irrigation device. In certain aspects the device is capable of one or more tasks that include, but are not limited to irrigation and soil moisture monitoring.

The irrigation system reduces water use by irrigating each point with an area with water volume determined by soil moisture, user specification, and environmental information. The technologies implemented in aspects of the invention are chosen to minimize environmental impact and provide financial benefit and convenience over other systems of irrigation.

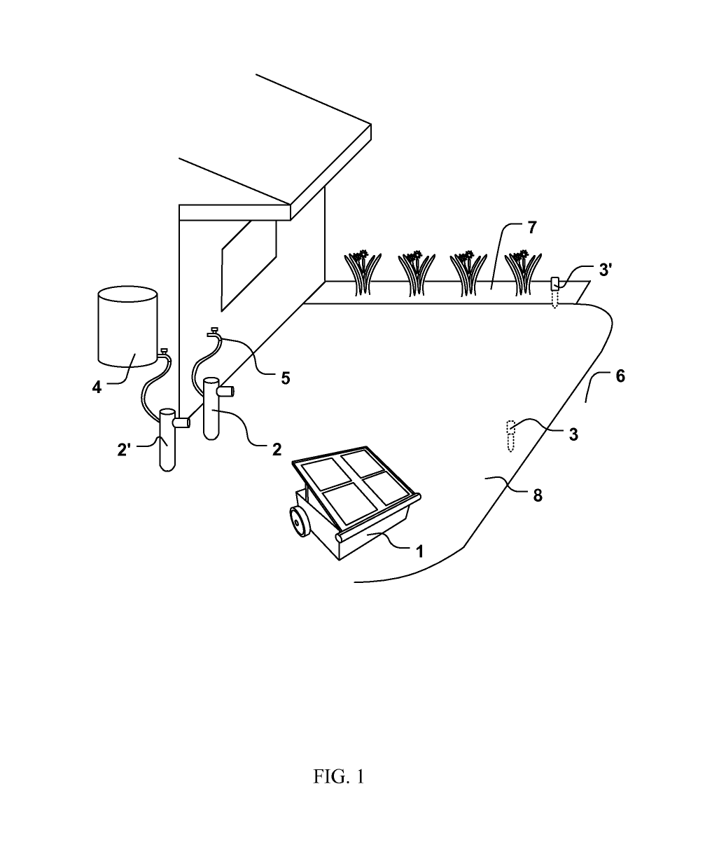

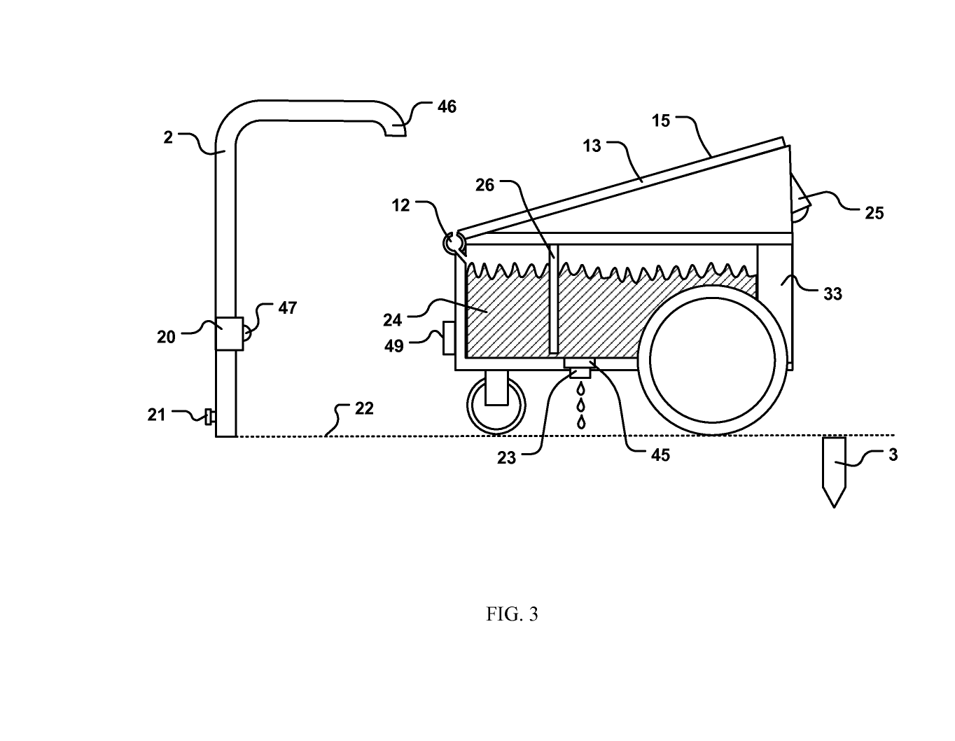

With reference to FIG. 3, in certain embodiments the system comprises a mobile robot 1 (an irrigator) with an autonomous navigation system, control module 33 and an integral water tank 24. With reference to FIG. 1, the robot 1 autonomously fills the water tank from a refill station 2, travels within the planted area 8, and irrigates vegetation before repeating the process. In this design, no fixed hose connection is required allowing the device to operate without the encumbrance of a tether.

In certain embodiments, the system incorporates one or more wireless radio-equipped beacons 3 for sensing soil moisture and providing positional information to the mobile irrigation robot 1. The moisture beacon 3 transmits the soil moisture information to the mobile robot 1 and to other beacons.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

The system comprises an autonomous mobile robot capable of distributing water to lawns and navigable planted areas. FIG. 1 shows, by way of example, the mobile robot operating in a lawn area. In FIG. 1, the device autonomously irrigates areas 8 within a defined perimeter by navigating the area as a grid. When the internal water tank 24 is empty, the mobile robot returns to one or more installed refill stations 2 to refill with water.

In FIG. 1, the mobile robot may return to the refill station 2 supplied by a pressurized water source from a tap 5, or to the refill station 2′ connected to a gravity-fed water source such as a rain water collection barrel 4. The benefits of using rain water compared to pressurized supply from city utility or private well are well understood.

The moisture beacons shown in FIG. 1 are installed primarily beneath the surface of the soil such that only the top cap 52, containing the antenna 29 is exposed. The moisture beacons monitor soil moisture and also act as navigation aids to the mobile robot in order to assist with positioning.

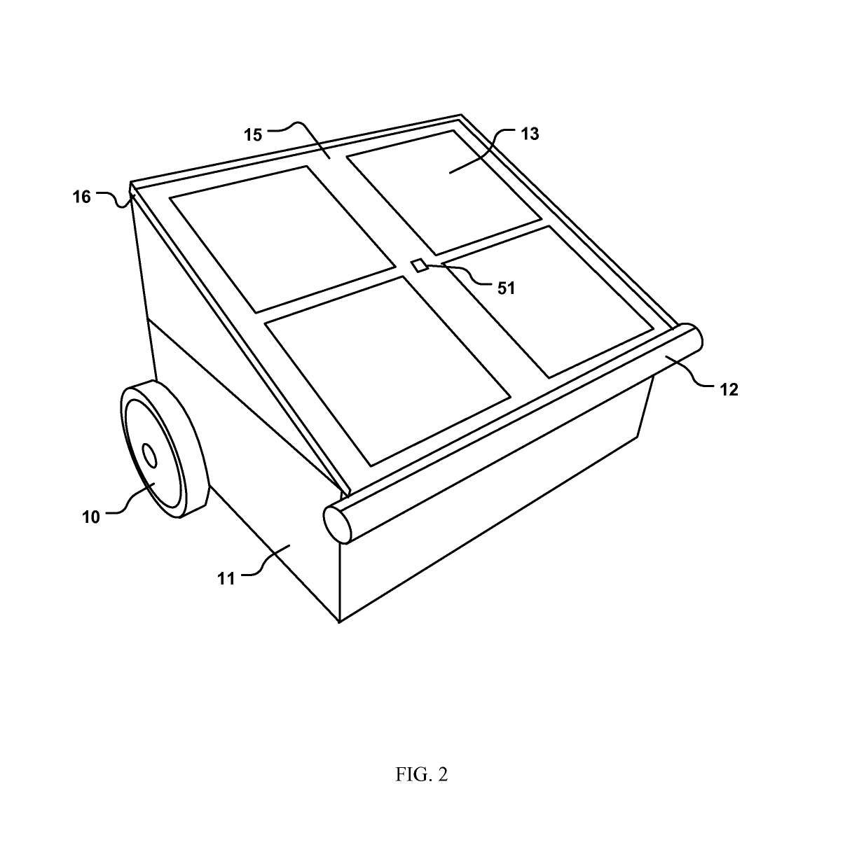

FIG. 2 shows an exterior view of the mobile robot highlighting the sloped water catchment roof 15 and gutter 12 for collecting water from the refill station. Here the sloped catchment roof consists of a single inclined plane, but the roof may also consist of multiple sloped planes and curved surfaces for the purpose of water collection. The roof 15 may also be wholly or partially composed of one or more photovoltaic panels 13. From the drawing it can be seen that the acceptable positional uncertainty of the mobile robot under the stream from the refill station is approximately one-half of the X and Y dimensions of the roof. This aspect provides a simple and reliable means of water transfer without a complex docking mechanism and without the need for a powered docking mechanism.

The sloped catchment roof 15 shown in FIG. 2 has the benefit of improving the performance of the photovoltaic panel 13. Photovoltaic output power under a given set of conditions is impacted by dirt on the surface of the panel. Each time the mobile robot refills, water from the refill station flushes the surface of the panel removing dirt that may have settled on the panel, thus sunlight is not blocked by the dirt particles. The refill process occurs regularly so the cleaning mechanism is predictable and reliable when considering a model for peak photovoltaic output.

In another aspect, the sloped catchment roof 15 of FIG. 2 improves photovoltaic panel performance by water cooling the photovoltaic panel 13. Photovoltaic cells are typically specified for an output power rating at 25° C. The output power being a function of the output voltage and load current, which combine to give the maximum power point. As the cell temperature increases, the voltage of each cell drops resulting in a reduced maximum power point. The voltage change is typically −0.35%/° C. resulting in considerable power loss at high temperature. By regularly refilling with water, the photovoltaic panels are cooled by the water stream entering the mobile robot, thereby improving the efficiency of the photovoltaic panels.

FIG. 3 shows a cross sectional view of the mobile robot 1 in proximity to the refill station 2 and the moisture beacon 3. In FIG. 3, the device comprises a water tank 24, a means for accepting water from a refill station into the water tank through a catchment channel 12, and one or more nozzles 23 for distributing water to the soil. A control module 33 contains a computer and electronic circuits for controlling a power system, a motorized drive mechanism, a camera vision system 25, an irrigation valve 45, and a radio for communicating with the moisture beacons and internet. The control module is electrically connected to these mechanisms and sensors. The control module also contains a rechargeable battery for storing electrical power from the photovoltaic panel 13 until it is required, for operation of at least the drive mechanism.

Once the water tank 24 in the mobile robot is full, the robot moves around the planted area 8, with the water flow from the tank to the nozzles controlled by a valve 45 or a pump, or gravity-fed. A valve located directly under the tank has the benefit of low power consumption as irrigation is accomplished by draining the water tank without additional electrical power. A water level sensor 26 measures the water remaining in the tank and the control module adjusts both the rate of travel and the valve position to provide consistent water flow as the water level in the tank 24 is depleted.

The refill station 2 comprises a spout 46, a control valve 20 activated by pressing on mechanical button 47, and a connection 21 to a supply hose or pipe.

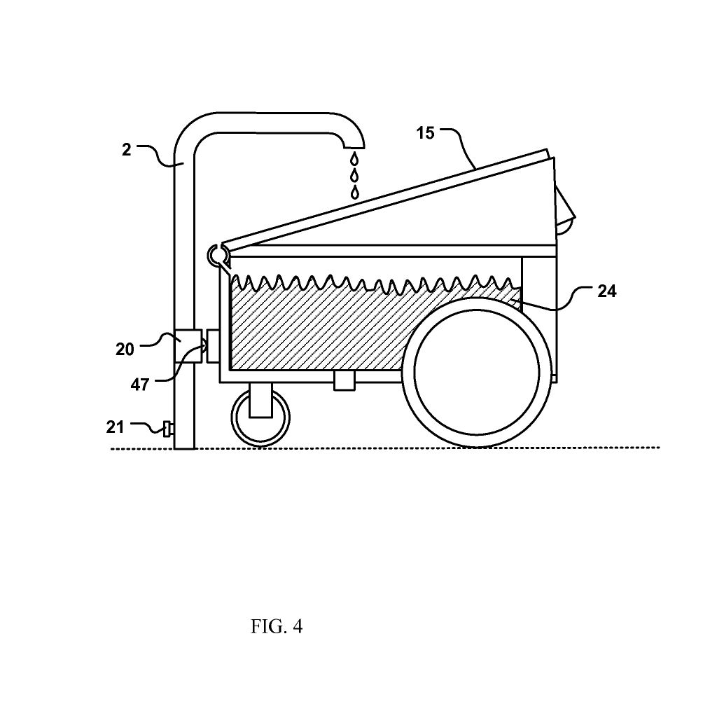

FIG. 4 shows the mobile robot 1 under the refill station 2 during the filling process. The mobile robot has a bumper 49 that opens water control valve 20 by depressing button 20 as the mobile robot moves into position under the spout 46. When the mobile robot determines that the water tank 24 is full, the mobile robot reverses releasing button 47 and stopping the water flow. Thus there is no requirement for the refill station to have an internal power source and the mobile robot can control the initiation and termination of the refill operation.

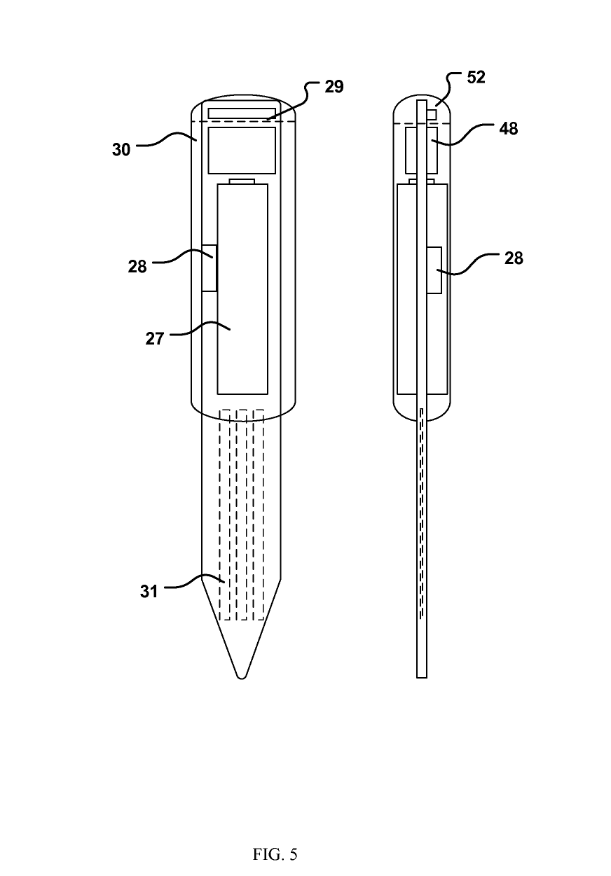

FIG. 5 shows a moisture beacon comprising a battery 27, wireless control circuit 48, tilt sensor 28, antenna 29, and moisture sensor 31 in a waterproof enclosure 30. The beacon periodically transmits soil moisture information to the mobile robot over a radio data link. The communication message includes a beacon identifier allowing the mobile robot to distinguish each beacon for the purpose of navigation. The moisture sensor 31 is sharpened to assist in penetrating into the soil. The tilt sensor 28 is activated when the sensor is moved while being initially installed or relocated by the user such that a message is sent to the irrigation device with notification of the change. Tilting or moving the beacon initiates radio pairing with the mobile robot such that the mobile robot can identify which beacons are within an operating area. The beacon may be installed with soil covering the moisture sensor only, or deeper in the soil such that only the top of the enclosure is visible. The beacon measures soil moisture by determining the dielectric constant of the surrounding soil. This allows the moisture sensor to be completely encapsulated by a waterproof enclosure. The moisture sensor consists of two electrical elements, one of which is driven by the control circuit 48 and the other measured by the same control circuit. A change in moisture in the soil will result in a change in the dielectric constant and a consequent change in capacitance will be detected by the control circuit.

The moisture beacon is commonly installed almost completely in soil making battery 27 replacement or charging impractical. The beacon assembly is completely sealed with over-molded plastic or similar polymer compound resulting in a low-cost disposable sensor. To preserve battery life the beacon transmits short infrequent radio messages in the order of once every 2 hours. The mobile robot is always in a state that is capable of receiving the messages. The mobile robot may optionally respond with an acknowledgement message that temporarily modifies the interval at which the moisture beacon sends messages.

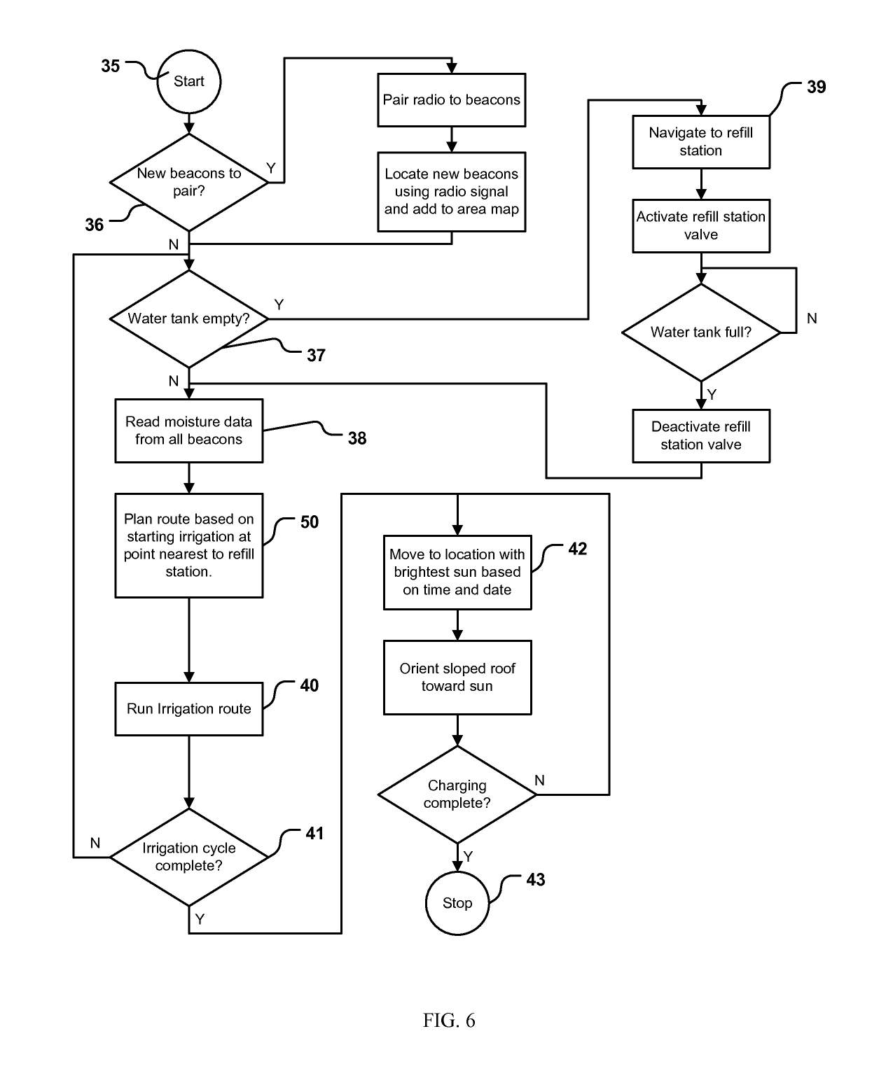

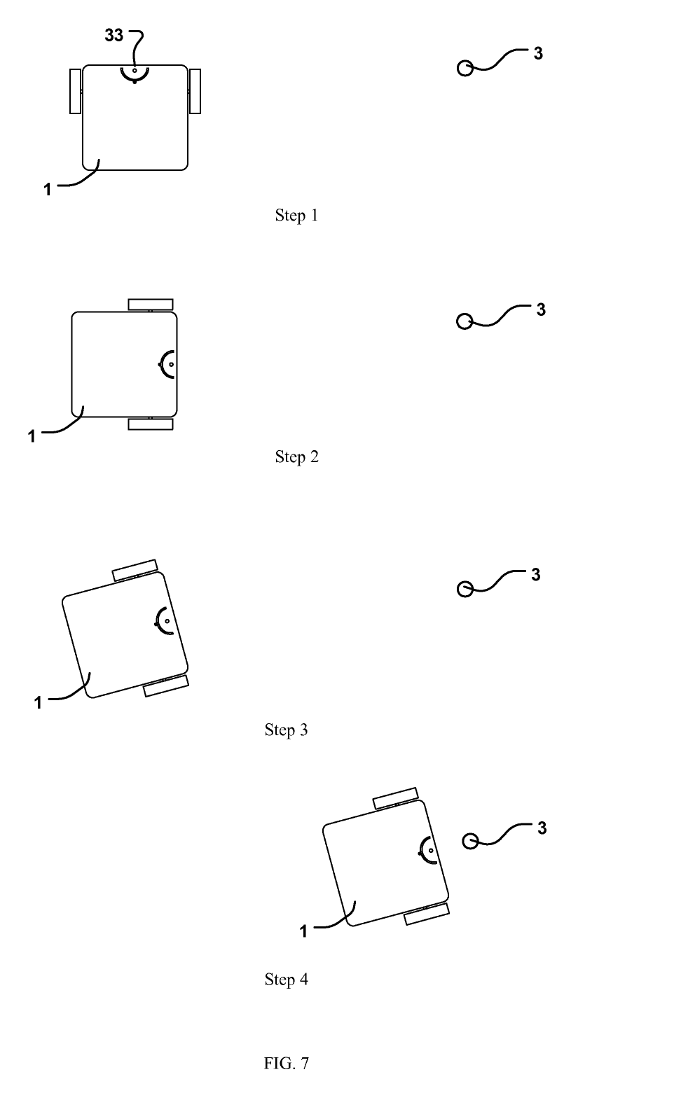

FIG. 6 shows the method used by the mobile irrigation device to complete a soil irrigation cycle using only solar power. The cycle 35 starts when directed by a user or by means of an electronic timer or computer schedule. The mobile robot checks for pairing signals 36 from new beacons. If new beacons are located, the mobile robot locates the new beacons and adds them to the area map stored in the robot's control module memory using coordinates from the boundary programmed by the persons installing the irrigation device. FIG. 7 shows the steps for locating new beacons using radio signal. The mobile robot determines if water tank is empty 37. If the tank is empty, the mobile robot navigates to the refill station. The means for locating the refill station may be the map stored in the control module or by following the edge of the planted area using the machine vision cameras

Once the tank is full, the mobile robot processes 38 moisture data from all moisture beacons before planning the initial route. The route is planned 50 by starting irrigation at the nearest point that requires irrigation and working in a direction away from the refill station. This method is based on reducing the water weight carried by the robot as early in the route as possible and minimizing the distance travelled on each irrigation route. The energy required by the drive motors reduces as irrigation proceeds so dry areas may be selectively irrigated first during each irrigation route.

The mobile robot then runs the route 40 distributing water in proportion to the moisture requirement of the soil adjacent to each moisture beacon. The moisture beacon periodically sends updated soil moisture information so that the mobile robot gets confirmation that the irrigation was complete and sufficient.

The irrigation cycle is determined complete 41 when the irrigation needs of the entire planted area have been met. In the next step 42, the mobile robot recharges the battery using solar energy. Use of solar energy is optimized by moving to a location in the area that provides the brightest sun based on historical information, the time of day, and the calendar date. The mobile robot rotates on its axis so that the photovoltaic panel faces the sun as the sun's position in the sky changes. As charging continues, the mobile robot determines based on historical information for that time of day whether there is a location offering brighter. Sun brightness may be determined by historical photovoltaic panel output power or by an ambient light sensor 51. When charging is complete the cycle ends and the mobile robot enters a low-power hibernate state until the next irrigation cycle. During the hibernate state the radio receiver in the control module is still active allowing reception of periodic moisture messages from the moisture beacons.

The position of the mobile robot with the planted area is determined by the control module 33 using positional information from several sources. The first positional source are the radio signals from the moisture beacons. The position of the mobile robot with respect to the beacons is determined by triangulating the signal direction based on receive signal strength from the beacon. During radio communication with each beacon the control module adjusts the electrical direction of the control module's antenna to determine the compass bearing that provides the strongest signal. This operation is completed for each paired beacon. The absolute position of each beacon is programmed into the control module by the user as a set of X-Y distances from the boundary of the planted area.

An additional source of positional information is from vectors calculated by the historical movement of the mobile robot. These vectors are generated by a closed-loop system consisting of a magnetometer to adjust bearing and either encoders on the drive motors or hall-effect sensors where brushless DC motors are used for propulsion

The perimeter of the area is determined using the camera vision system 25. When the mobile robot is installed, the robot follows the perimeter of the area using cameras to detect the transition from grass or other plants to boundary elements including pavement, curbs and fences. The image processing requirements are minimized by having the cameras face the ground thereby avoiding complex geometric analysis in three dimensions. The image processing consists of reducing the pixelated image to a smaller number of tiles, where each tile represents a filtered version of those pixels. Each tile represents an area approximately equal to the target irrigation accuracy of ½ inch. Each tile is expressed in terms color, in this implementation a set numeric values representing the Red, Green and Blue color components. By applying rules based on tile values the planted or lawn area can be distinguished from surrounding areas. Thus, the camera vision system can be implemented on a microcontroller with integral program and data memory rather than a microprocessor requiring external memory.

The control module 33 combines the beacon position information with position information from the camera vision system 25 and the movement vectors. The fusion of this position information is weighted toward cameras when the mobile robot is close to an edge and toward beacon position when directly positioned by a moisture beacon. Positioning uncertainty must be minimized to ensure water is distributed only on planted areas 7 8 and not on paved areas 6.

By this method and devices described in this invention solar power stored in the battery is used efficiently. This allows the mobile robot to operate only using only solar energy.

FIG. 7 illustrates navigation using radio beacons and a directional antenna. The mobile robot 1 sweeps the orientation of a directional antenna 33 by rotating on its axis, or by using a servo or electrical means, such that the angle of optimal moisture beacon 3 signal strength is measured. The device then adjusts the direction of travel towards said angle in a control loop that repeats continuously until the device is directly above the moisture beacon. Using this method, the mobile robot can locate and store the position of newly added beacons with the requirement for additional configuration steps. Moisture beacons can be quickly added whenever the layout of the planted area changes or when the user determines that additional localized moisture data is beneficial.

1. A system for optimally irrigating soil, comprising:
a mobile irrigator comprising:
a mobile chassis having wheels or tracks for motion, the chassis having one or more water sprinklers with streams directed at the soil,
a water storage tank in communication with the sprinklers, and
a sloped catchment surface having one or more sloped planes or curved surfaces for receiving water into the water storage tank,
wherein, under the control of an electronic circuit, the mobile irrigator is configured to fill the water tank by positioning any part of the catchment surface under a water stream.

2. The system of claim 1, the mobile irrigator further comprising photovoltaic solar panels mounted on the sloped catchment surface.

3. The system of claim 1, the mobile irrigator further comprising a bumper, wherein the mobile irrigator can activate an electric water valve on a refill station.

4. The system of claim 1, further comprising a plurality of wireless moisture beacons in communication with the circuit, wherein moisture information and position information by way of radio signal strength is received by the irrigator.

5. The system of claim 1, the mobile irrigator further comprising one or more machine vision cameras, oriented to face the ground and providing a camera view of the ground to the control module, wherein the control module is configured to determine the transition between the planted area and the surrounding paved areas and direct the irrigator.

6. The system of claim 1, the mobile irrigator further comprising a water release valve, located under the water tank and connected to an irrigation nozzle.

7. The system of claim 1, the mobile irrigator further comprising a refill station connected to a gravity fed water source.

8. A method for optimally irrigating soil using solar energy, comprising the steps of:
measuring soil moisture at remote locations using a plurality of wireless moisture beacons,
refilling a mobile robot using a water stream onto a catchment roof,
determining one or more routes for distribution of water based on watering the driest areas first,
traversing the routes and distributing water according to soil moisture measurements for each location.

9. The method of claim 7 further comprising the step of storing photovoltaic energy in a battery optimally, by moving to the sunniest location based on time of day, historical data, environmental conditions, latitude and longitude.

10. The method of claim 7 further comprising the step of rotating, while route navigation is paused, to a compass heading such that the photovoltaic array is optimally oriented with respect to the sun's position for peak photovoltaic output power.
